(19) United States
(12) Patent Application Publication
(10) Pub. No.: US 2026/0313021 A1
(43) Pub. Date: Oct. 8, 2026

(54) METHOD AND APPARATUS FOR EAS DISCOVERY AND SYNCHRONIZATION ACROSS EDNS FOR APPLICATION GROUP

(71) Applicant: Telefonaktiebolaget LM Ericsson (publ), Stockholm (SE)

(72) Inventor: Wenliang XU, Shanghai (CN)

(21) Appl. No.: 19/483,816

(22) PCT Filed: May 14, 2024
(86) PCT No.: PCT/CN2024/092998

§ 371 Date: Nov. 12, 2025

(30) Foreign Application Priority Data
May 15, 2023 (WO) PCT/CN2023/094158

(51) Int. Cl. H04L 67/1095; H04L 67/51; H04L 67/63

(52) U.S. Cl. CPC H04L 67/1095; H04L 67/51; H04L 67/63

(57) ABSTRACT

Embodiments of the present disclosure provide method and apparatus for EAS discovery and synchronization across EDNs for application group. A method performed by an edge application server (EAS) may include sending a first request to an edge enabler server (EES) or a central repository. The first request may be used for obtaining information of at least one common EAS currently serving an application group or subscribing for a common EAS availability event for the application group. The application group is a group of UEs using a same application. The first request includes an application group identifier identifying the application group. The method may further include receiving a first message from the EES or the central repository. The first message may include common EAS information for the application group.

### PRIORITY CLAIM

This present application claims priority from PCT international application No. PCT/CN2023/094158, filed on May 15, 2023, the disclosure of which is incorporated by reference herein in its entirety.

### TECHNICAL FIELD

The non-limiting and exemplary embodiments of the present disclosure generally relate to the technical field of communications, and specifically to methods and apparatuses for edge application servers (EAS) discovery and synchronization across Edge Data Networks (EDNs) for application group.

### BACKGROUND

This section introduces aspects that may facilitate a better understanding of the disclosure. Accordingly, the statements of this section are to be read in this light and are not to be understood as admissions about what is in the prior art or what is not in the prior art.

Edge computing is a concept that enables services to be hosted close to the service consumers and provides benefits such as efficient service delivery with significant reduction in end-to-end latency and decreased load on the transport network. The benefits of edge computing will strengthen the promise of fifth generation (5G) and expand the prospects for several new and enhanced use cases—including virtual and augmented reality, Internet of Things (IoT), Industrial IoT, autonomous driving, real-time multiplayer gaming, etc.

3rd Generation Partnership Project (3GPP) Technical Specification (TS) 23.558 V18.2.0, the disclosure of which is incorporated by reference herein in its entirety, specifies application layer architecture, procedures and information flows necessary for enabling edge applications over 3GPP networks. It includes architectural requirements for enabling edge applications, application layer architecture fulfilling the architecture requirements and procedures to enable the deployment of edge applications.

FIG. 1a shows a reference point representation of the architecture for edge enabling applications, which is same as FIGS. 6.2-4 of 3GPP TS 23.558 V18.2.0.

The EDN is a local Data Network. Edge Application Server(s) (EAS) and Edge Enabler Server(s) (EES) are contained within the EDN. The Edge Configuration Server (ECS) may provide configurations related to the Edge Enabler Server, including details of the EDN hosting the Edge Enabler Server. The use equipment (UE) contains Application Client(s) (AC) and Edge Enabler Client (EEC). The Edge Application Server(s) (EAS), the Edge Enabler Server (EES) and the ECS may interact with the 3GPP core network. When Service Enabler Layer Architecture (SEAL) notification management service is used, the EES and the ECS interacts with the SEAL notification management server and the SEAL Edge Enabler Client interacts with SEAL Notification management client.

The functional entities may include:

### Edge Enabler Server (EES)

EES may provide supporting functions needed for EASs and EEC.

Functionalities of EES may comprise at least one of:
a) provisioning of configuration information to EEC, enabling exchange of application data traffic with the EAS;
b) providing Application Programming Interface (API) invoker and API exposing functions as specified in 3GPP TS 23.222 V18.1.0;
c) interacting with 3GPP Core Network for accessing the capabilities of network functions either directly (e.g. via Policy Control Function (PCF)) or indirectly (i.e. SCEF (Service Capability Exposure Function/Network Exposure Function/Service Capability Exposure Function combined with Network Exposure Function (SCEF/NEF/SCEF+NEF);
d) exposing events related to Application Context Transfer (ACT);
e) EEC context transfer between EESs;
f) supporting external exposure of 3GPP network and service capabilities to the EAS(s) over EDGE-3;
g) registration functions (i.e., registration, update, and de-registration) for the EEC(s) and the EAS(s);
h) triggering the EAS instantiation on demand; and
i) supporting application context relocation (ACR) related operations (e.g. ACR launching, ACR information notification, Edge Enabler layer (EEL) Managed ACR).

### Edge Enabler Client (EEC)

EEC may provide supporting functions needed for AC(s).

Functionalities of EEC may comprise at least one of:
a) retrieval of configuration information to enable the exchange of Application Data Traffic with the EAS;
b) discovery of EASs available in the EDN; and
c) detecting UE mobility events.

### Edge Configuration Server (ECS)

ECS may provide supporting functions needed for the EEC to connect with an EES.

Functionalities of ECS may comprise at least one of:
a) provisioning of Edge configuration information to the EEC. The Edge configuration information includes the following:
1) the information for the EEC to distinguish amongst the EESs (e.g. EDN service area); and
2) the information for establishing a connection with EESs (such as Uniform Resource Identifier (URI));
b) providing the target EES (T-EES) information to the source EES (S-EES);

The ECS can be deployed in the Mobile Network Operator (MNO) domain or can be deployed in 3rd party domain by service provider.
c) supporting the functionalities of registration (i.e., registration, update, and de-registration) for the EES(s);
d) supporting the functionalities of API invoker and API exposing function as specified in 3GPP TS 23.222 V18.1.0;
e) interacting with 3GPP Core Network for accessing the capabilities of network functions either directly (e.g. via PCF) or indirectly (i.e. SCEF/NEF/SCEF+NEF).
f) providing service provisioning information to a partner ECS; and
g) retrieving service provisioning information from a partner ECS.

If the Edge Computing Service Provider (ECSP) is required to support service provisioning for a certain EAS whose information is not within the preconfiguration or Operations, Administration and Maintenance (OAM) configuration, the ECS can use Edge repository functions to support ECS discovery via Edge Configuration Server-Edge Repository (ECS-ER). To support functions of the edge repository the ECS supports the following functionality(ies):
a) registering and providing edge deployment information to ECS-ER.

To support functions of the edge repository the functionalities of the enhanced ECS i.e. ECS-ER, in addition to ECS functionalities, are:
a) supporting the functionalities of registration (i.e., registration, update, and de-registration) for the ECS(s);
b) receiving and storing information about edge computing resources from the ECS(s);
c) receiving and storing information about edge computing resources from other ECS-ER(s); and
d) providing information about Edge computing resources to other ECS-ER(s) of the federation.

### Application Client (AC)

AC is the application resident in the UE performing the client function. Depending on how ACR is implemented, the AC might be required to decide whether to initiate ACR.

### Edge Application Server (EAS)

EAS is the application server resident in the EDN, performing the server functions. The AC connects to the EAS in order to avail the services of the application with the benefits of Edge Computing.

It is possible that the server functions of an application are available only as an EAS.

However, it is also possible that certain server functions are available both at the edge and in the cloud, as an EAS and an Application Server resident in the cloud respectively. The server functions offered by an EAS and its cloud Application Server counterpart may be the same or may differ; if they differ, the Application Data Traffic exchanged with the AC may also be different.

The EAS can consume the 3GPP Core Network capabilities in the following ways, all of which are optional to support:
a) invoking 3GPP Core Network capabilities via the edge enabler layer through the EES
b) invoking 3GPP Core Network function (e.g. PCF) APIs directly, if it is an entity trusted by the 3GPP Core Network; and
c) invoking the 3GPP Core Network capabilities through the capability exposure functions i.e. SCEF/NEF/SCEF+NEF.

The EAS can support processing ACR related operations (e.g. ACR status update, selected target EAS declaration).

The EAS can expose its Service API(s) (i.e., EAS Service API(s)) towards the other EASs by supporting API provider domain functions as specified in TS 23.222 V18.1.0; and the EAS can consume the EAS Service API(s) exposed by the other EAS(s) by supporting API invoker functionalities as specified in TS 23.222 V18.1.0.

### Notification Management Client

The notification management client functional entity acts as the application client for notification management aspects. It interacts with the notification management server. It handles the notification messages received from the notification management server and deliver it to the corresponding Vertical Application Layer (VAL) clients residing on the VAL UE.

The notification management (NM) client functional entity is supported by the Hyper Text Transfer Protocol (HTTP) client functional entities of the signaling control plane.

### Notification Management Server

The notification management server is a functional entity that handles the notification management aspects by interacting with the notification management client and the VAL servers. The notification management server receives the notification messages from the vertical application layer and delivers it to the notification management client.

The reference points of the architecture for enabling edge applications may comprise:
EDGE-1 reference point enables interactions between the EES and the EEC,
EDGE-2 reference point enables interactions between the EES and the 3GPP Core Network functions and APIs for retrieval of network capability information,
EDGE-3 reference point enables interactions between the EES and the EASs,
EDGE-4 reference point enables interactions between the ECS and the EEC,
EDGE-5 reference point enables interactions between AC(s) and the EEC,
EDGE-6 reference point enables interactions between the ECS and the EES,
EDGE-7 reference point enables interactions between the EAS and the 3GPP Core Network functions and APIs for retrieval of network capability information,
EDGE-8 reference point enables interactions between the ECS and the 3GPP Core Network functions and APIs for retrieval of network capability information,
EDGE-9 reference point enables interactions between two EESs,
NM-UU: The interactions related to notification management functions between the notification management client and the notification management server are supported by NM-UU reference point. This reference point utilizes Uu reference point as described in 3GPP TS 23.401 V18.1.0 and 3GPP TS 23.501 V18.0.0,
NM-C: The interactions related to notification management functions between the VAL client(s) and the notification management client within a VAL UE are supported by NM-C (client) reference point,
NM-S: The interactions related to notification management functions between the VAL server(s) and the notification management server are supported by NM-S (server) reference point.

In 3GPP TR 23.700-98 V18.1.0, the disclosure of which is incorporated by reference herein in its entirety, key issue (KI) #17 is discovery of a common EAS.

An Application Service Provider (ASP) can deploy several EASs providing the same service in different locations within the EDN.

For certain use cases involving real-time communication in a multi-user session, both between AC and EAS and between different ACs via the EAS, it may be necessary or beneficial to use services from a single common EAS to meet the strict latency requirements and to avoid the need for inter-EAS synchronization. The use cases may include, for example, a team of robots coordinating together on a manufacturing floor, a team of surgeons using Virtual Reality (VR) headsets and robotic surgery equipment to operate together on a patient, or a group of trucks using Vehicle-to-Everything (V2X) for platooning.

Dependent on the use case, the EEL may apply different additional criteria to determine this common EAS. E.g. it could be desirable to determine the EAS so that the latency for all the ACs in the session is approximately the same or that the latency for a specific AC is minimized.

FIG. 1b shows an example of several EASs (with same service) deployed in different locations in the same EDN, which is same as FIGS. 4.17-1 of 3GPP TR 23.700-98 V18.1.0.

As shown several EASs for the same service (identified by EAS identifier (ID)) are deployed in the same EDN1.

The solution for common EAS was agreed in 3GPP Technical Specification Groups—Service and System Aspects (TSG-SA) Working Group 6 (WG6) Meeting #54, S6-231648, “Common EAS discovery”, 17-26 Apr. 2023 and Central Repository function was introduced to facilitate common EAS discovery and selection.

Key issue 13 in TR 23.700-98 V18.1.0 is edge enabler layer support for EAS synchronization. When UEs are connecting to the same EAS (i.e. common EAS) in their corresponding EDN, there is a need to synchronize information between common EASs. For instance, in online multi-user game, the players can be distributed in different locations (e.g. city north and city south, city north has edge coverage with EDN1 and city south has edge coverage with EDN2), when those players are teamed up to play the multi-user game, the selected common EAS in city north needs to synchronize game data with the selected common EAS in city south serving the same Application Group.

FIG. 1c shows an example of EAS (with same service) deployed by same ASP in different EDNs, which is same as FIGS. 4.13-1 of 3GPP TR 23.700-98 V18.1.0.

It is possible that common EAS in an EDN serves only one UE. In a special case, one UE is connected to EAS-1X in EDN1 and another UE is connected to EAS-2X in EDN2, and EAS-1X and EAS-2X need to synchronize data (both UEs are in the same group).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Some solutions (such as Solutions #28-31) of 3GPP TR 23.700-98 V18.1.0 addresses open issues 1 and 2 of key issue #17 of 3GPP TR 23.700-98 V18.1.0.

### Open Issues of Key Issue #17:

1) Whether and how the ACs/EECs of Different Users can Select or be Provisioned the Same EAS within an EDN?

This open issue is dealing with the issue how different EECs can perform EAS discovery so that they select the same EAS within an EDN, whereas KI #13 of 3GPP TR 23.700-98 V18.1.0 is dealing with the issue how, after different EECs have selected different EASs located in different EDNs, these EASs can synchronize their contexts.

2) Whether and how the ACs/EECs of Different Users can Select or be Provisioned a Common EAS, Even if Initially the EECs are Communicating with Different EDNs?

Currently, there is no solution providing service to EAS to look up common EAS selected for application group. So far, the procedure to support EAS to EAS synchronization in EEL is not specified.

To overcome or mitigate at least one above mentioned problems or other problems, a solution for EAS discovery and synchronization across EDNs for application group may be desirable.

In a first aspect of the disclosure, there is provided a method performed by an edge application server (EAS). The method may comprise sending a first request to an edge enabler server (EES) or a central repository. The first request may be used for obtaining information of at least one common EAS currently serving an application group or subscribing for a common EAS availability event for the application group. The method may further comprise receiving a first message from the EES or the central repository. The first message may comprise common EAS information for the application group.

In an embodiment, the application group may be a group of UEs using a same application.

In an embodiment, the first request may comprise an application group identifier identifying the application group.

In an embodiment, the first request may comprise first information for determining the common EAS information for the application group.

In an embodiment, the first request may comprise first information for determining the common EAS information for the application group and an event identifier of common EAS availability change.

In an embodiment, the first request may further comprise an identifier of a requestor.

In an embodiment, the first information may comprise a first set of characteristics for determining the common EAS information for the application group.

In an embodiment, the first set of characteristics may comprise an EAS identifier and the application group identifier.

In an embodiment, the first request may comprise at least one of an EAS discovery request or an EAS discovery subscription request.

In an embodiment, the first message may comprise at least one of an EAS discovery response or an EAS discovery notification.

In an embodiment, if the EAS is a first EAS serving the application group and the first request is an EAS discovery request, the common EAS information for the application group may comprise an empty EAS list.

In an embodiment, the EAS is serving or is going to serve the application group.

In an embodiment, the method may further comprise starting data synchronization with at least one common EAS identified by the common EAS information for the application group.

In an embodiment, at least one common EAS for the application group may be deployed in a same edge data network or different edge data networks.

In a second aspect of the disclosure, there is provided a method performed by an edge enabler server (EES). The method may comprise receiving a first request from an edge application server (EAS). The first request may be used for obtaining information of at least one common EAS currently serving an application group or subscribing for a common EAS availability event for the application group. The method may further comprise sending a first message to the EAS. The first message may comprise common EAS information for the application group.

In an embodiment, the application group may be a group of UEs using a same application.

In an embodiment, the first request may comprise an application group identifier identifying the application group.

In an embodiment, the first request may comprise first information for determining the common EAS information for the application group.

In an embodiment, the first request may comprise first information for determining the common EAS information for the application group and an event identifier of common EAS availability change.

In an embodiment, the first request may further comprise an identifier of a requestor.

In an embodiment, the first information may comprise a first set of characteristics for determining the common EAS information for the application group.

In an embodiment, the first set of characteristics may comprise an EAS identifier and the application group identifier.

In an embodiment, the first request may comprise at least one of an EAS discovery request or an EAS discovery subscription request.

In an embodiment, the first message may comprise at least one of an EAS discovery response or an EAS discovery notification.

In an embodiment, if the EAS is a first EAS serving the application group and the first request is an EAS discovery request, the common EAS information for the application group comprised in the first message may comprise an empty EAS list.

In an embodiment, the EAS is serving or is going to serve the application group.

In an embodiment, at least one common EAS for the application group may be deployed in a same edge data network or different edge data networks.

In an embodiment, the method may further comprise sending a second request to a central repository. The second request may be used for obtaining the information of the at least one common EAS currently serving the application group or subscribing for the common EAS availability event for the application group. In an embodiment, the second request may comprise the application group identifier identifying the application group. The method may further comprise receiving a second message from the central repository. The second message may comprise the common EAS information for the application group.

In an embodiment, the second request may comprise second information for determining the common EAS information for the application group.

In an embodiment, the second request may comprise second information for determining the common EAS information for the application group and an event identifier of common EAS availability event.

In an embodiment, the second request may further comprise at least one of an identifier of the EES or security credentials.

In an embodiment, the second request may further comprise at least one of an identifier of the EES, security credentials, or a notification target address.

In an embodiment, the second information may comprise a second set of characteristics for determining the common EAS information for the application group.

In an embodiment, the second set of characteristics may comprise an EAS identifier and the application group identifier.

In an embodiment, the second request may comprise at least one of a common EAS information get request or a common EAS information subscription request.

In an embodiment, the second message may comprise at least one of a common EAS information get response or a common EAS information notification.

In an embodiment, when the second message is a common EAS information get response, the common EAS information get response may comprise at least one of an information element indicating that the second request is successful or failed, the common EAS information for the application group when the second request is successful, or a failure cause when the second request is failed.

In an embodiment, when the second message is a common EAS information notification, the common EAS information notification may comprise at least one of a subscription identifier, an event identifier or the common EAS information for the application group.

In an embodiment, when the second request is a common EAS information subscription request, the method may further comprise receiving a common EAS information subscription response from the central repository.

In an embodiment, the common EAS information subscription response may comprise at least one of an information element indicating that the second request is successful or failed, a subscription identifier when the second request is successful, or a failure cause when the second request is failed.

In a third aspect of the disclosure, there is provided a method performed by a central repository. The method may comprise receiving a second request from an edge enabler server (EES) or a first request from an edge application server (EAS). The first request and/or the second request may be used for obtaining information of at least one common edge application server (EAS) currently serving an application group or subscribing for a common EAS availability event for the application group. The method may comprise sending a second message to the EES or a first message to the EAS. The first message and/or the second message may comprise common EAS information for the application group.

In an embodiment, the application group may be a group of UEs using a same application.

In an embodiment, the first request and/or the second request may comprise an application group identifier identifying the application group.

In an embodiment, the first request and/or the second request may comprise information for determining the common EAS information for the application group.

In an embodiment, the first request and/or the second request may comprise information for determining the common EAS information for the application group and an event identifier of common EAS availability event.

In an embodiment, the first request and/or the second request may further comprise at least one of an identifier of a requestor, or security credentials.

In an embodiment, the first request and/or the second request may further comprise at least one of an identifier of a requestor, security credentials, or a notification target address.

In an embodiment, the information for determining the common EAS information for the application group may comprise a set of characteristics for determining the common EAS information for the application group.

In an embodiment, the set of characteristics may comprise an EAS identifier and the application group identifier.

In an embodiment, the first request and/or the second request may comprise at least one of an EAS discovery request, an EAS discovery subscription request, a common EAS information get request, or a common EAS information subscription request.

In an embodiment, the first message and/or the second message may comprise at least one of an EAS discovery response, an EAS discovery notification, a common EAS information get response, or a common EAS information notification.

In an embodiment, when the second message is a common EAS information get response or the first request is an EAS discovery response, the common EAS information get response or the EAS discovery response may comprise at least one of an information element indicating that the first/second request is successful or failed, the common EAS information for the application group when the first/second request is successful, or a failure cause when the first/second request is failed.

In an embodiment, when the second message is a common EAS information notification or the first message is an EAS discovery notification, the common EAS information notification or the EAS discovery notification may comprise at least one of a subscription identifier, an event identifier, or the common EAS information for the application group.

In an embodiment, when the second request is a common EAS information subscription request, the method may further comprise sending a common EAS information subscription response to the EES.

In an embodiment, the common EAS information subscription response may comprise at least one of an information element indicating that the second request is successful or failed, a subscription identifier when the second request is successful, or a failure cause when the second request is failed.

In a fourth aspect of the disclosure, there is provided an EAS. The EAS comprises a processor and a memory coupled to the processor. Said memory contains instructions executable by said processor. The EAS may be operative to send a first request to an edge enabler server (EES) or a central repository. The first request may be used for obtaining information of at least one common EAS currently serving an application group or subscribing for a common EAS availability event for the application group. The EAS may be further operative to receive a first message from the EES or the central repository. The first message may comprise common EAS information for the application group. In an embodiment, the application group may be a group of UEs using a same application. In an embodiment, the first request may comprise an application group identifier identifying the application group.

In a fifth aspect of the disclosure, there is provided an EES. The EES comprises a processor and a memory coupled to the processor. Said memory contains instructions executable by said processor. The EES may be operative to receive a first request from an edge application server (EAS). The first request may be used for obtaining information of at least one common EAS currently serving an application group or subscribing for a common EAS availability event for the application group. The EES may be further operative to send a first message to the EAS. The first message comprises common EAS information for the application group. In an embodiment, the application group may be a group of UEs using a same application. In an embodiment, the first request may comprise an application group identifier identifying the application group.

In a sixth aspect of the disclosure, there is provided a central repository. The central repository comprises a processor and a memory coupled to the processor. Said memory contains instructions executable by said processor. The central repository may be operative to receive a second request from an edge enabler server (EES) or a first request from an edge application server (EAS). The first request and/or the second request may be used for obtaining information of at least one common edge application server (EAS) currently serving an application group or subscribing for a common EAS availability event for the application group. The central repository may be further operative to send a second message to the EES or a first message to the EAS. The first message and/or the second message may comprise common EAS information for the application group. In an embodiment, the application group may be a group of UEs using a same application. In an embodiment, the first request and/or the second request may comprise an application group identifier identifying the application group.

In a seventh aspect of the disclosure, there is provided an EAS. The EAS may comprise a sending module configured to send a first request to an edge enabler server (EES) or a central repository. The first request may be used for obtaining information of at least one common EAS currently serving an application group or subscribing for a common EAS availability event for the application group. The EAS may further comprise a receiving module configured to receive a first message from the EES or the central repository. The first message may comprise common EAS information for the application group. In an embodiment, the application group may be a group of UEs using a same application. In an embodiment, the first request may comprise an application group identifier identifying the application group.

In an embodiment, the EAS may further comprise a starting module configured to start data synchronization with at least one common EAS identified by the common EAS information for the application group.

In an eighth aspect of the disclosure, there is provided an EES. The EES may comprise a first receiving module configured to receive a first request from an edge application server (EAS). The first request may be used for obtaining information of at least one common EAS currently serving an application group or subscribing for a common EAS availability event for the application group. The EES may further comprise a first sending module configured to send a first message to the EAS. The first message may comprise common EAS information for the application group. In an embodiment, the application group may be a group of UEs using a same application. In an embodiment, the first request may comprise an application group identifier identifying the application group.

In an embodiment, the EES may further comprise a second sending module configured to send a second request to a central repository. The second request may be used for obtaining the information of the at least one common EAS currently serving the application group or subscribing for the common EAS availability event for the application group. In an embodiment, the second request may comprise the application group identifier identifying the application group.

In an embodiment, the EES may further comprise a second receiving module configured to receive a second message from the central repository. The second message may comprise the common EAS information for the application group.

In an embodiment, when the second request is a common EAS information subscription request, the EES may further comprise a third receiving module configured to receive a common EAS information subscription response from the central repository.

In a ninth aspect of the disclosure, there is provided a central repository. The central repository may comprise a receiving module configured to receive a second request from an edge enabler server (EES) or a first request from an edge application server (EAS). The first request and/or the second request may be used for obtaining information of at least one common edge application server (EAS) currently serving an application group or subscribing for a common EAS availability event for the application group. The central repository may further comprise a first sending module configured to send a second message to the EES or a first message to the EAS. The first message and/or the second message may comprise common EAS information for the application group. In an embodiment, the application group may be a group of UEs using a same application. In an embodiment, the first request and/or the second request may comprise an application group identifier identifying the application group.

In an embodiment, when the second request is a common EAS information subscription request, the central repository may further comprise a second sending module configured to send a common EAS information subscription response to the EES.

In a tenth aspect of the disclosure, there is provided a computer program product comprising instructions which when executed by at least one processor, cause the at least one processor to perform the method according to any one of the first, second or third aspects.

In an eleventh aspect of the disclosure, there is provided a computer-readable storage medium storing instructions which when executed by at least one processor, cause the at least one processor to perform the method according to any one of the first, second or third aspects.

Embodiments herein may provide many advantages, of which a non-exhaustive list of examples follows. In some embodiments herein, the proposed solution can support EAS to find other EASs providing the same service to the same application group. In some embodiments herein, the proposed solution can allow the EAS to start data synchronization with obtained common EASs. In some embodiments herein, a new service is provided by the Central Repository (CR) to offer common EAS information available in the CR so that other network function such as EAS can use the obtained common EAS information for various purposes. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a reference point representation of the architecture for edge enabling applications;

FIG. 1b shows an example of several EASs (with same service) deployed in different locations in the same EDN;

FIG. 1c shows an example of EAS (with same service) deployed by same ASP in different EDNs;

FIG. 2a schematically shows a high level architecture in the fifth generation network according to an embodiment of the present disclosure;

FIG. 2b schematically shows a high level architecture in a 4G network according to an embodiment of the present disclosure;

FIG. 3a shows a flowchart of a method according to an embodiment of the present disclosure;

FIG. 3b shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 6a shows a flowchart of common EAS retrieval procedure according to another embodiment of the present disclosure;

FIG. 6b shows a flowchart of common EAS availability subscription procedure according to another embodiment of the present disclosure;

FIG. 6c shows a flowchart of common EAS availability notification according to another embodiment of the present disclosure;

FIG. 6d shows a flowchart of obtaining common EAS according to another embodiment of the present disclosure;

FIG. 6e shows a flowchart of subscribing common EAS information according to another embodiment of the present disclosure;

FIG. 6f shows a flowchart of notifying common EAS information according to another embodiment of the present disclosure;

FIG. 7 is a block diagram showing an apparatus suitable for practicing some embodiments of the disclosure;

FIG. 8a is a block diagram showing an EAS according to an embodiment of the disclosure;

FIG. 8b is a block diagram showing an EES according to an embodiment of the disclosure;

FIG. 8c is a block diagram showing a central repository according to another embodiment of the disclosure;

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

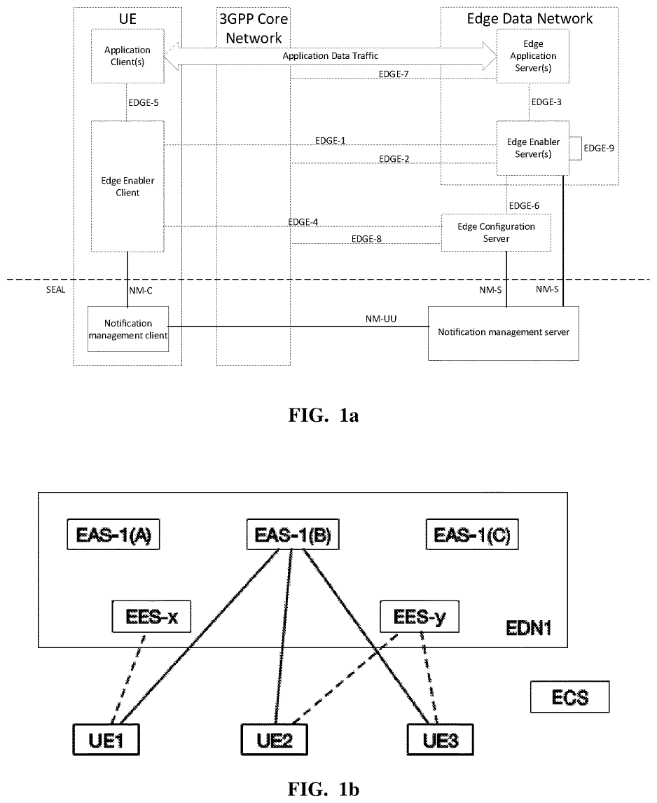

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as Access and Mobility Management Function (AMF), Session Management Function (SMF), Authentication Service Function (AUSF), Unified Data Management (UDM), Policy Control Function (PCF), Application Function (AF), Network Exposure Function (NEF), User plane Function (UPF) and Network Repository Function (NRF), radio access network (RAN), service communication proxy (SCP), network data analytics function (NWDAF), Network Slice Selection Function (NSSF), Network Slice-Specific Authentication and Authorization Function (NSSAAF), etc. For example, the 4G system (such as Long Term Evolution (LTE)) may include Mobile Management Entity (MME), home subscriber server (HSS), PCRF (Policy and Charging Rules Function), PGW (Packet Data Network Gateway), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

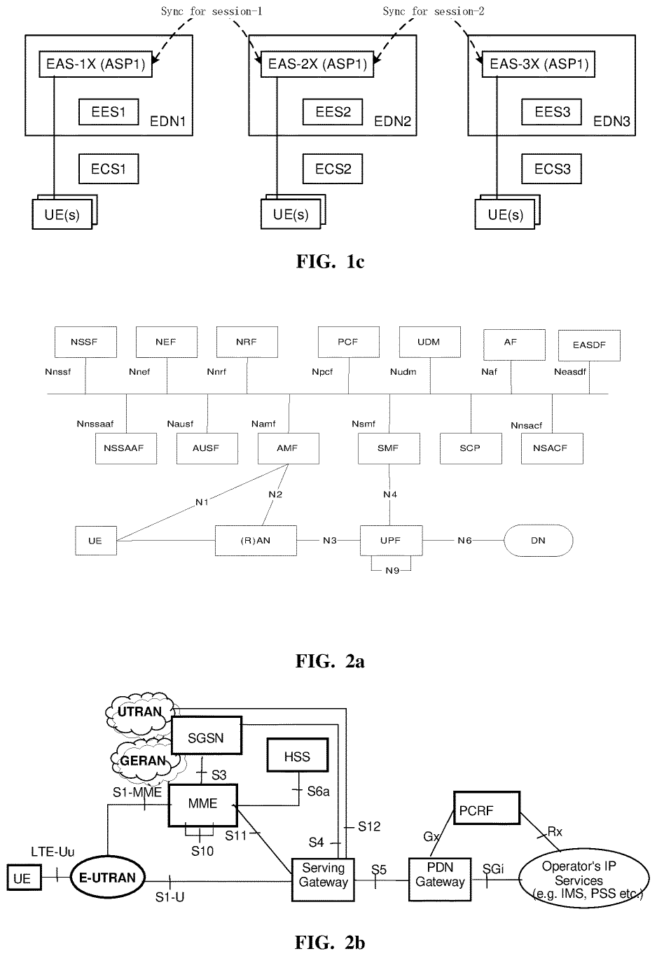

Although the subject matter described herein may be implemented in any appropriate type of system using any suitable components, the embodiments disclosed herein are described in relation to a communication system complied with the exemplary system architectures illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

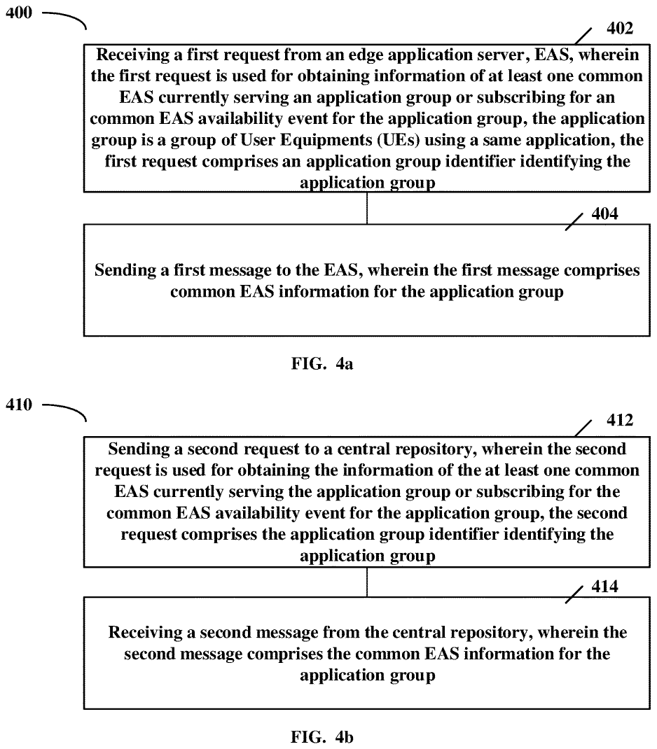

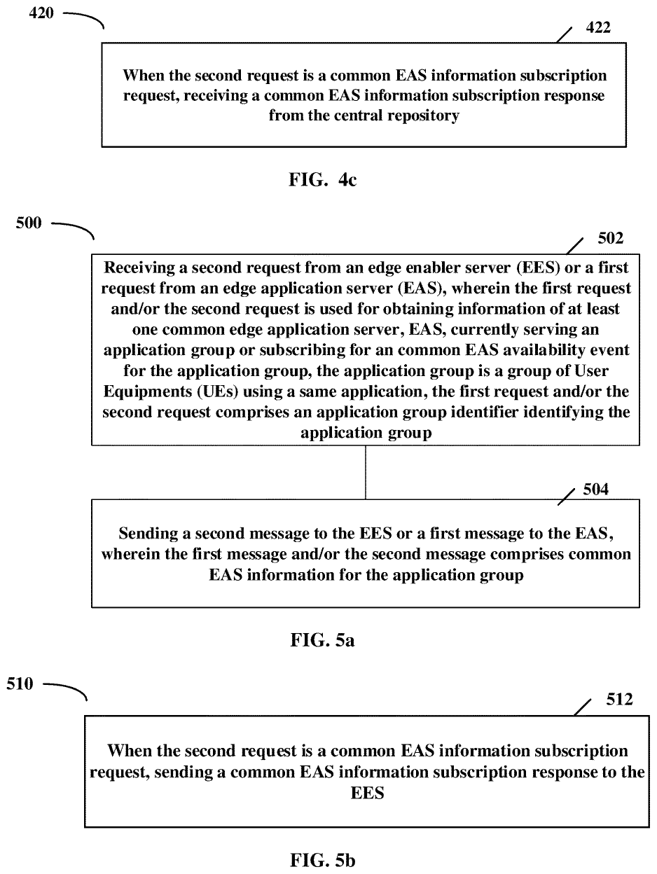

FIG. 2a schematically shows a high level architecture in the fifth generation network according to an embodiment of the present disclosure. The architecture of FIG. 2a is same as FIG. 4.2.3-1 of 3GPP TS 23.501 V18.0.0, the disclosure of which is incorporated by reference herein in its entirety. The system architecture of FIG. 2a may comprise some exemplary elements such as AUSF, AMF, data network (DN), NEF, NRF, NSSF, PCF, SMF, UDM, UPF, AF, UE, (R)AN, Service Communication Proxy (SCP), Network Slice-Specific Authentication and Authorization Function (NSSAAF), Network Slice Admission Control Function (NSACF), Edge Application Server Discovery Function (EASDF), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 2a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

FIG. 2b schematically shows a high level architecture in a 4G network according to an embodiment of the present disclosure, which is same as FIG. 4.2.1-1 of 3GPP TS 23.401 V18.1.0, the disclosure of which is incorporated by reference herein in its entirety. The system architecture of FIG. 2b may comprise some exemplary elements such as home subscriber server (HSS), UE, Evolved Universal Terrestrial Radio Access Network (E-UTRAN), Serving General Packet Radio Service (GPRS) Support Node (SGSN), Mobile Management Entity (MME), Serving Gateway (S-GW), Packet Data Network (PDN) Gateway, PCRF, etc. UTRAN denotes Universal Terrestrial Radio Access Network. GERAN denotes GSM EDGE Radio Access Network. IMS denotes Internet protocol (IP) Multimedia Subsystem. PSS denotes Packet-switched Streaming Service (PSS). Gx is the reference point between PCRF and PDN gateway and it provides transfer of (QoS) policy and charging rules from PCRF to Policy and Charging Enforcement Function (PCEF) in the PDN gateway. The network elements and interfaces as shown in FIG. 2b may be same as the corresponding network elements and interfaces as described in 3GPP TS 23.401 V18.1.0.

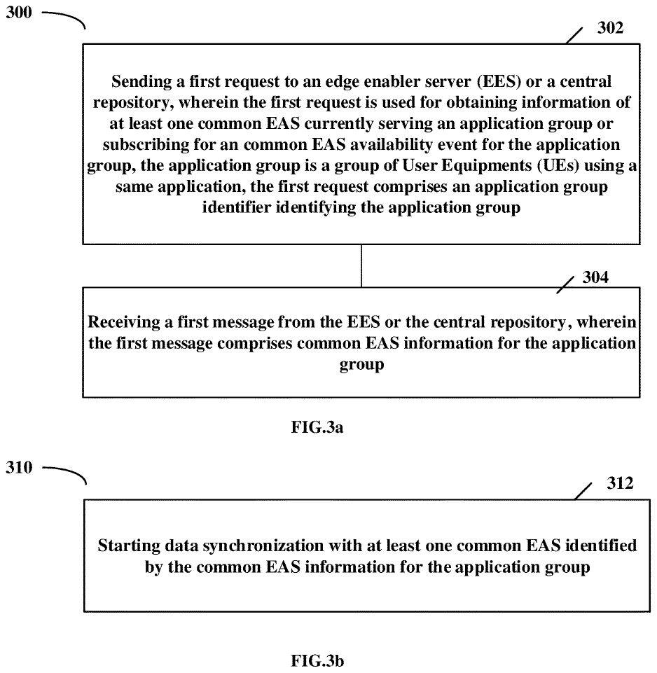

FIG. 3a shows a flowchart of a method according to an embodiment of the present disclosure, which may be performed by an apparatus implemented in or at or as an edge application server (EAS) or communicatively coupled to the EAS. As such, the apparatus may provide means or modules for accomplishing various parts of the method 300 as well as means or modules for accomplishing other processes in conjunction with other components.

At block 302, the EAS may send a first request to an edge enabler server (EES) or a central repository. The first request may be used for obtaining information of at least one common EAS currently serving an application group or subscribing for a common EAS availability event for the application group.

In an embodiment, the application group may be a group of UEs using a same application.

In an embodiment, the first request may comprise an application group identifier identifying the application group.

In an embodiment, the EES may be same or similar as/to the EES as described in 3GPP TS 23.558 V18.2.0.

In an embodiment, the EAS may be same or similar as/to the EAS as described in 3GPP TS 23.558 V18.2.0.

The central repository may be a repository function which may store and/or provide common EAS information. In an embodiment, EES may interact with the central repository to store the common EAS information for example as described in S6-231648.

The central repository may be a separate network function (e.g. a standalone server) or implemented or co-located in a network function such as ECS. For example, an ECS can be enhanced to support discovery of a common EAS for a set of UEs. Such enhanced ECSs may have the central repository functionality. In an embodiment, the central repository may be similar to the central repository as described in S6-231648.

In an embodiment, the EAS is serving or is going to serve the application group. For example, the EAS is a common EAS or to be a common EAS. In an embodiment, the first request may be sent to the EES when the EAS is serving or is going to serve the application group.

The first request may be any suitable request such as an existing request or a new request. In an embodiment, the first request may comprise at least one of an EAS discovery request or an EAS discovery subscription request. For example, the EAS discovery request or the EAS discovery subscription request may be similar to the corresponding requests as described in 3GPP TR 23.700-98 V18.1.0, S6-231648 or 3GPP TS 23.558 V18.2.0 except that it is used by EAS to obtain information of at least one common EAS currently serving an application group or subscribe for a common EAS availability event for the application group.

Several EASs providing the same service may be deployed in different locations within the same EDN or different EDNs. For example, these EASs providing the same service and serving an application group may be referred to as common EASs.

In an embodiment, at least one common EAS for the application group may be deployed in a same edge data network or different edge data networks. The edge data network may be a local data network that supports the architecture for enabling edge applications for example as described in 3GPP TS 23.558 V18.2.0.

In an embodiment, the common EAS may be same or similar as/to the common EAS as described in 3GPP TR 23.700-98 V18.1.0.

Application group may comprise a group of UEs using the same application. Application Group ID may uniquely identify a group of UEs using the same application. It may be allocated (either dynamically or pre-configured in the AC) by the ASP and may be unique within the application. ACs supporting the same application on different operation system (OS) (IOS, Android) can have the same application group ID.

Application group ID may be assumed to be unique per EAS ID. An application group may be assumed to correspond to a single application.

In an embodiment, the application group may be same or similar as/to the application group as described in S6-231648.

The first request may comprise any suitable information which can be used to determine at least one common EAS currently serving an application group.

In an embodiment, the first request may comprise first information for determining the common EAS information for the application group. The first information may be any suitable information which can be used to determine the common EAS information for the application group. For example, the first information may be common discovery EAS filters. The common discovery EAS filters may be any suitable filters and the present disclosure has no limit on it. In this embodiment, the first request may be an EAS discovery request.

In an embodiment, the first request may comprise first information for determining the common EAS information for the application group and an event identifier of common EAS availability change. In this embodiment, the first request may be an EAS discovery subscription request. It is noted that in addition to the event identifier of common EAS availability change, other information element with the similar/same meanings may also be used.

In an embodiment, the first information may comprise a first set of characteristics for determining the common EAS information for the application group. The first set of characteristics may comprise any suitable information which can be used to determine the common EAS for the application group. The first set of characteristics may be applicable for common EAS availability change event.

In an embodiment, the first set of characteristics may comprise an EAS identifier and the application group identifier. In other embodiment, the first set of characteristics may comprise any other suitable information for determining the common EAS for the application group.

The EAS identifier may identify a particular application for e.g. Video, Game etc. For example, all common EASs may share the same EAS identifier. The definition of the EAS identifier may be any suitable forms and the present disclosure has no limit on it.

In an embodiment, the EAS identifier may be same or similar as/to the EASID as described in 3GPP TR 23.700-98 V18.1.0, S6-231648 or 3GPP TS 23.558 V18.2.0.

The application group identifier may be an identity/identifier of a group of UEs using the same application. In an embodiment, the application group identifier may be same or similar as/to the application group ID as described in 56-231648.

In an embodiment, the first request may further comprise an identifier of a requestor. For example, the identifier of the requestor may be a unique identifier of the EAS.

At block 304, the EAS may receive a first message from the EES or the central repository. The first message may comprise common EAS information for the application group.

The first message may be any suitable message such as an existing message or a new message.

In an embodiment, the first message may comprise at least one of an EAS discovery response or an EAS discovery notification. For example, the EAS discovery response or the EAS discovery notification may be similar to the corresponding messages as described in 3GPP TR 23.700-98 V18.1.0, S6-231648 or 3GPP TS 23.558 V18.2.0. For example, if the first request is an EAS discovery request, the first message may be an EAS discovery response. If the first request is an EAS discovery subscription request, the first message may be an EAS discovery notification.

In an embodiment, if the EAS is a first EAS serving the application group and the first request is an EAS discovery request, the common EAS information for the application group may comprise an empty EAS list.

The common EAS information for the application group may comprise any suitable information. For example, the common EAS information for the application group may comprise a list of discovered common EAS(s). The information of a common EAS may include at least one of EAS profile (for example as described in Table 8.2.4-1 of 3GPP TS 23.558 V18.2.0) or lifetime. In an embodiment, the EAS profile of a common EAS for the application group may comprise EAS endpoint and EAS ID. The lifetime may indicate a time interval or duration during which the information elements in the EAS profile is valid and supposed to be cached in the EEC or EAS (e.g. time-to-live value for an EAS Endpoint).

In an embodiment, the common EAS information for the application group may comprise endpoint information of the common EAS for the application group. For example, the endpoint information of a common EAS may comprise e.g. Uniform Resource Identifier (URI), Fully Qualified Domain Name (FQDN), Internet protocol (IP) address of the common EAS, etc.

The common EAS information for the application group may be used by the EAS for various purposes (such as data synchronization, load balance, disaster tolerance, disaster recovery, etc.) and the present disclosure has no limit on it.

In an embodiment, when the first request is an EAS discovery subscription request, the EAS may receive an EAS discovery subscription response from the EES. For example, if the processing (such as authorization, etc.) of the first request is successful or failed, the EES may send an EAS discovery subscription response to the EAS.

FIG. 3b shows a flowchart of a method according to another embodiment of the present disclosure, which may be performed by an apparatus implemented in or at or as the EAS or communicatively coupled to the EAS. As such, the apparatus may provide means or modules for accomplishing various parts of the method 310 as well as means or modules for accomplishing other processes in conjunction with other components.

At block 312, the EAS may start data synchronization with at least one common EAS identified by the common EAS information for the application group.

For example, the EAS may use the common EAS information for the application group to obtain the endpoint information of the at least one common EAS, establish a connection with the at least one common EAS, and then start data synchronization with the at least one common EAS.

FIG. 4a shows a flowchart of a method according to another embodiment of the present disclosure, which may be performed by an apparatus implemented in or at or as an EES or communicatively coupled to the EES. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the EES may receive a first request from an edge application server (EAS). The first request may be used for obtaining information of at least one common EAS currently serving an application group or subscribing for a common EAS availability event for the application group.

In an embodiment, the application group may be a group of UEs using a same application.

In an embodiment, the first request may comprise an application group identifier identifying the application group.

In an embodiment, the EES may authorize the first request. If the first request is authorized (e.g., EAS is authorized to communicate with the EES, or perform the common EAS discovery or subscription, etc.), the EES may further process the first request, e.g. obtaining the common EAS information for the application group. If the first request is not authorized, the EES may send a failure response indicating that the first request has failed to the EAS. For example, when the first request is an EAS discovery subscription request and the first request is authorized, the EES may create and store the subscription for common EAS discovery. If a central repository is available, the EES may subscribe to the central repository with event indicating common EAS availability, EAS ID and application group ID. When the first request is an EAS discovery request and the first request is authorized, the EES may obtain the common EAS information for the application group. For example, if a central repository is available, the EES may send a common EAS information get request with EAS ID and application group ID to the central repository and receive a common EAS information get response comprising the common EAS information for the application group from the central repository. Alternatively, if the common EAS information for the application group is stored or cached in the EES, the EES may obtain the common EAS information for the application group locally.

In an embodiment, the first request may comprise first information for determining the common EAS information for the application group.

In an embodiment, the first request may comprise first information for determining the common EAS information for the application group and an event identifier of common EAS availability change.

In an embodiment, the first request may further comprise an identifier of a requestor.

In an embodiment, the first information may comprise a first set of characteristics for determining the common EAS information for the application group.

In an embodiment, the first set of characteristics may comprise an EAS identifier and the application group identifier.

In an embodiment, the first request may comprise at least one of an EAS discovery request or an EAS discovery subscription request.

At block 404, the EES may send a first message to the EAS. The first message may comprise common EAS information for the application group.

The EES may obtain the common EAS information for the application group in various ways and the present disclosure has no limit on it. For example, the EES may store or cache the common EAS information for the application group, and in this case it may obtain the common EAS information for the application group locally. Alternatively, the EES may obtain the common EAS information for the application group from another device which stores the common EAS information for the application group or can retrieve the common EAS information for the application group from a storing function.

In an embodiment, the first message may comprise at least one of an EAS discovery response or an EAS discovery notification.

In an embodiment, if the EAS is a first EAS serving the application group and the first request is an EAS discovery request, the common EAS information for the application group comprised in the first message may comprise an empty EAS list.

In an embodiment, the EAS is serving or is going to serve the application group.

In an embodiment, at least one common EAS for the application group may be deployed in a same edge data network or different edge data networks.

FIG. 4b shows a flowchart of a method according to another embodiment of the present disclosure, which may be performed by an apparatus implemented in or at or as the EES or communicatively coupled to the EES. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the EES may send a second request to a central repository. The second request may be used for obtaining the information of the at least one common EAS currently serving the application group or subscribing for the common EAS availability event for the application group. In an embodiment, the second request may comprise the application group identifier identifying the application group.

The second request may be any suitable request such as an existing request or a new request. In an embodiment, the second request may comprise at least one of a common EAS information get request or a common EAS information subscription request.

The second request may comprise any suitable information which can be used to determine the common EAS for the application group. In an embodiment, the second request may comprise second information for determining the common EAS information for the application group. The second information may be any suitable information which can be used to determine the common EAS information for the application group. For example, the second information may be common discovery EAS filters. The common discovery EAS filters may be any suitable filters and the present disclosure has no limit on it. In this embodiment, the second request may be a common EAS information get request.

In an embodiment, the second request may comprise second information for determining the common EAS information for the application group and an event identifier of common EAS availability event. In this embodiment, the second request may be a common EAS information subscription request.

In an embodiment, the second information may comprise a second set of characteristics for determining the common EAS information for the application group. The second set of characteristics may comprise any suitable information which can be used to determine the common EAS for the application group. The second set of characteristics may be applicable for common EAS availability change event.

In an embodiment, the second set of characteristics may comprise an EAS identifier and the application group identifier. In other embodiment, the second set of characteristics may comprise any other suitable information for determining the common EAS for the application group.

In an embodiment, the second request may further comprise at least one of an identifier of the EES or security credentials. The security credentials may result from a successful authorization for the edge computing service. In this embodiment, the second request may be a common EAS information get request.

In an embodiment, the second request may further comprise at least one of an identifier of the EES, security credentials, or a notification target address. The notification target address may indicate a notification target address where the notification is to be sent. In this embodiment, the second request may be a common EAS information subscription request.

At block 414, the EES may receive a second message from the central repository. The second message may comprise the common EAS information for the application group.

The second message may be any suitable message such as an existing message or a new message.

In an embodiment, the second message may comprise at least one of a common EAS information get response or a common EAS information notification.

For example, when the second request is a common EAS information get request, the second message may be a common EAS information get response. When the second request is a common EAS information subscription request, the second message may be a common EAS information notification.

In an embodiment, if the EAS is a first EAS serving the application group and the second request is a common EAS information get request, the common EAS information for the application group may comprise an empty EAS list.

In an embodiment, when the second message is a common EAS information get response, the common EAS information get response may comprise at least one of an information element indicating that the second request is successful or failed, the common EAS information for the application group when the second request is successful, or a failure cause when the second request is failed.

In an embodiment, when the second message is a common EAS information notification, the common EAS information notification may comprise at least one of a subscription identifier, an event identifier, or the common EAS information for the application group.

FIG. 4c shows a flowchart of a method according to another embodiment of the present disclosure, which may be performed by an apparatus implemented in or at or as the EES or communicatively coupled to the EES. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, when the second request is a common EAS information subscription request, the EES may receive a common EAS information subscription response from the central repository.

In an embodiment, the common EAS information subscription response may comprise at least one of an information element indicating that the second request is successful or failed, a subscription identifier when the second request is successful, or a failure cause when the second request is failed.

For example, upon receiving the common EAS information subscription request, the central repository may authorize the common EAS information subscription request and store the event subscription. If the processing of the common EAS information subscription request was successful, the central repository may respond the EES with common EAS information subscription response message.

FIG. 5a shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the central repository may receive a second request from an edge enabler server (EES) or a first request from an edge application server (EAS). The first request and/or the second request may be used for obtaining information of at least one common edge application server (EAS) currently serving an application group or subscribing for a common EAS availability event for the application group.

In an embodiment, the application group may be a group of UEs using a same application.

In an embodiment, the first request and/or the second request may comprise an application group identifier identifying the application group.

In an embodiment, the central repository may authorize the first/second request. If the first/second request is authorized (e.g., EAS/EES is authorized to communicate with the central repository, or perform the common EAS discovery or subscription, etc.), the central repository may further process the first/second request, e.g. obtaining the common EAS information for the application group. If the first/second request is not authorized, the central repository may send a failure response indicating that the first/second request has failed to the EAS/EES. For example, when the first/second request is a subscription request and the first/second request is authorized, the central repository may create and store the subscription for common EAS discovery. When the first/second request is an EAS discovery request or a common EAS information get request and the first/second request is authorized, the central repository may obtain the common EAS information for the application group.

At block 504, the central repository may send a second message to the EES or a first message to the EAS. The first message and/or the second message may comprise common EAS information for the application group.

In an embodiment, the first request and/or the second request may comprise information for determining the common EAS information for the application group.

In an embodiment, the first request and/or the second request may comprise information for determining the common EAS information for the application group and an event identifier of common EAS availability event.

In an embodiment, the first request and/or the second request may further comprise at least one of an identifier of a requestor, or security credentials.

In an embodiment, the first request and/or the second request may further comprise at least one of an identifier of a requestor, security credentials, or a notification target address.

In an embodiment, the information for determining the common EAS information for the application group may comprise a set of characteristics for determining the common EAS information for the application group.

In an embodiment, the set of characteristics may comprise an EAS identifier and the application group identifier.

In an embodiment, the first request and/or the second request may comprise at least one of an EAS discovery request, an EAS discovery subscription request, a common EAS information get request, or a common EAS information subscription request.

In an embodiment, the first message and/or the second message may comprise at least one of an EAS discovery response, an EAS discovery notification, a common EAS information get response, or a common EAS information notification.

In an embodiment, when the second message may be a common EAS information get response or the first request is an EAS discovery response, the common EAS information get response or the EAS discovery response may comprise at least one of an information element indicating that the first/second request is successful or failed, the common EAS information for the application group when the first/second request is successful, or a failure cause when the first/second request is failed.

In an embodiment, when the second message is a common EAS information notification or the first message is an EAS discovery notification, the common EAS information notification or the EAS discovery notification may comprise at least one of a subscription identifier, an event identifier, or the common EAS information for the application group.

FIG. 5b shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, when the second request is a common EAS information subscription request, the central repository may send a common EAS information subscription response to the EES.

In an embodiment, the common EAS information subscription response may comprise at least one of an information element indicating that the second request is successful or failed, a subscription identifier when the second request is successful, or a failure cause when the second request is failed.

According to various embodiments, it may allow the EAS to query common EAS information so that it can use the common EAS information for various purposes such as starting data synchronization with the obtained common EASs.

According to various embodiments, a new service is provided by the central repository (CR) to offer common EAS information available in the CR to various network function such as EAS.

According to various embodiments, it may add a procedure to support EAS to find other EASs providing the same service to the same application group.

In an embodiment, clause 8.5.3.2 of 3GPP TS 23.558 V18.2.0 may be amended as following. It is noted that in addition to common discovery EAS filters in Table 8.5.3.2-1, other information element with the similar/same meanings may also be used.

### 8.5.3.2 EAS Discovery Request

Table 8.5.3.2-1 describes information elements for the EAS discovery request. Table 8.5.3.2-2 provides further detail about the EAS Discovery Filter information element.

TABLE 8.5.3.2-1
EAS discovery request

| Information | | |
|---|---|---|
| element | Status | Description |
| Requestor | M | The ID of the requestor (e.g. EECID) |
| identifier | | |
| UE Identifier | O | The identifier of the UE (i.e. GPSI or identity |
| | | token) |
| Security | M | Security credentials resulting from a successful |
| credentials | | authorization for the edge computing service. |
| EAS discovery | O | Set of characteristics to determine required |
| filters | | EASs, as detailed in Table 8.5.3.2-2. |
| Common | O | Common EAS discovery filters, as detailed in |
| discovery | | Table 8.5.3.2-x. |
| EAS filters | | |
| UE location | O | The location information of the UE. The UE |
| | | location is described in clause 7.3.2. |
| Serving MNO | O | The serving MNO information (e.g. MNO |
| information | | name, PLMN ID) which is serving the |
| (NOTE 2) | | subscriber. |
| Target DNAI | O | Target DNAI information which can be |
| (NOTE 1) | | associated with potential T-EAS(s) |
| EEC Service | O | Indicates if the EEC supports service continuity |
| Continuity | | or not. The IE also indicates which ACR |
| Support | | scenarios are supported by the EEC or, if this |
| | | message is sent by the EEC to discover a |
| | | T-EAS, which ACR scenario(s) are intended to |
| | | be used for the ACR. |
| EES Service | O | The IE indicates if the S-EES supports service |
| Continuity | | continuity or not. The IE also indicates which |
| Support | | ACR scenarios are supported by the S-EES or, |
| (NOTE 1) | | if the EAS discovery is used for an S-EES |
| | | executed ACR according to clause 8.8.2.5, |
| | | which ACR scenario is to be used for the ACR. |
| EAS Service | O | The IE indicates if the S-EAS supports service |
| Continuity | | continuity or not. The IE also indicates which |
| Support | | ACR scenarios are supported by the S-EAS or, |
| (NOTE 1) | | if the EAS discovery is used for an S-EAS |
| | | decided ACR according to clause 8.8.2.4, which |
| | | ACR scenario is to be used for the ACR. |
| EAS | O | Indicates to the EES that EAS instantiation |
| Instantiation | | triggering should not be performed for the |
| Triggering | | current request. |
| Suppress | | |
| EAS selection | O | Indicates the request for EAS selection support |
| request indicator | | from the EES (e.g., for constrained device). |

NOTE 1:
This IE shall not be included when the request originates from the EEC.
NOTE 2:
This IE shall be included if edge node sharing is used.

TABLE 8.5.3.2-2
EAS discovery filters

| Information | | |
|---|---|---|
| element | Status | Description |
| List of AC | O | Describes the ACs for which a |
| characteristics | | matching EAS is needed. |
| (NOTE 1) | | |
| >AC profile | M | AC profile containing parameters |
| (NOTE 2) | | used to determine matching EAS. |
| | | AC profiles are further described in |
| | | Table 8.2.2-1. |
| List of EAS | O | Describes the characteristic of |
| characteristics | | required EASs. |
| (NOTE 1, | | |
| NOTE 3) | | |
| >EASID | O | Identifier of the required EAS. |
| >Bundle ID or list | O | A list of EASIDs or a bundle ID as |
| of EASID | | described in clause 7.2.10. |
| >EAS provider | O | Identifier of the required EAS |
| identifier | | provider |
| >EAS type | O | The category or type of required EAS |
| | | (e.g. V2X) |
| >EAS schedule | O | Required availability schedule of the |
| | | EAS (e.g. time windows) |
| >EAS | O | Location(s) (e.g. geographical area, |
| Geographical | | route) where the EAS service should |
| Service Area | | be available. |
| >EAS | O | Topological area (e.g. cell ID, TAI) |
| Topological | | for which the EAS service should |
| Service Area | | be available. See possible formats |
| | | in Table 8.2.7-1. |
| >Service | O | Indicates if the service continuity |
| continuity support | | support is required or not. |
| >Service | O | Required level of service permissions |
| permission level | | e.g. trial, gold-class |
| >Service feature(s) | O | Required service features e.g. single |
| | | vs. multi-player gaming service |

NOTE 1:
Either “List of AC characteristics” or “List of EAS characteristics” shall be present.
NOTE 2:
“Preferred ECSP list” IE shall not be present.
NOTE 3:
The “List of EAS characteristics” IE must include at least one optional IE, if used as an EAS discovery filter.

TABLE 8.5.3.2-x
Common EAS discovery filters

| Information element | Status | Description |
|---|---|---|
| List of common EAS | M | List of common EAS information |
| information filters | | |
| >EASID | M | Identifier of the EAS |
| >Application Group ID | M | Identity of a group of UEs using |
| | | the same application. |

It is noted that in addition to list of common EAS information filters in Table 8.5.3.2-x, other information element with the similar/same meanings may also be used. The list of common EAS information filters may comprise any other suitable information element.

In an embodiment, clause 8.5.3.3 of 3GPP TS 23.558 V18.2.0 is as following.

### 8.5.3.3 EAS Discovery Response

Table 8.5.3.3-1 describes information elements for the EAS discovery response from the EES to the EEC.

TABLE 8.5.3.3-1
EAS discovery response

| Information | | |
|---|---|---|
| element | Status | Description |
| Successful | O | Indicates that the EAS discovery request was |
| response | | successful. |
| >Discovered EAS | O | List of discovered EAS(s). Each element |
| list (see NOTE 1) | | includes the information described below. |
| >>EAS profile | M | Profile of the EAS. Each element is described |
| | | in clause 8.2.4 |
| >>Lifetime | O | Time interval or duration during which the |
| | | information elements in the EAS profile is |
| | | valid and supposed to be cached in the |
| | | EEC (e.g. time-to-live value for an EAS |
| | | Endpoint) |
| >Instantiable | O | The EAS instantiation status per EASID (e.g. |
| EAS Information | | instantiated, instantiable but not |
| (see NOTE 1) | | instantiated yet) |
| >Instantiation | O | The criteria upon which EAS can be |
| criteria | | instantiated (e.g. based on specific |
| (see NOTE 2) | | date and time). |
| Failure response | O | Indicates that the EAS discovery request failed. |
| >Cause | O | Indicates the cause of EAS discovery request |
| | | failure. |

NOTE 1:
At least one of the IEs must be included in the Successful response.
NOTE 2:
“Instantiation criteria” IE shall be present only when the value of “Instantiable EAS information” IE is “instantiable but not be instantiated yet”.

In an embodiment, clause 8.5.3.4 of 3GPP TS 23.558 V18.2.0 may be amended as following. It is noted that in addition to common EAS availability change in Table 8.5.3.4-1, other Event ID with the similar/same meanings may also be used.

### 8.5.3.4 EAS Discovery Subscription Request

Table 8.5.3.4-1 describes the information elements for EAS discovery subscription request from the EEC to the EES.

TABLE 8.5.3.4-1
EAS discovery subscription request

| Information | | |
|---|---|---|
| element | Status | Description |
| Requestor ID | M | Unique identifier of the EEC or EAS. |
| UE Identifier | O | The identifier of the UE (i.e. GPSI or identity |
| | | token) |
| Event ID | M | Event ID: |
| | | EAS availability change |
| | | EAS dynamic information change |
| | | Common EAS availability change |
| Security | M | Security credentials resulting from a successful |
| credentials | | authorization for the edge computing service. |
| Notification | O | The Notification target address (e.g. URL) |
| Target Address | | where the notifications destined for the EEC |
| | | should be sent to. |
| EAS discovery | O | Set of characteristics to determine matching |
| filters | | EASs (as detailed in Table 8.5.3.2-2). |
| | | Applicable for “EAS availability change” event |
| EAS dynamic | O | List of dynamic information changes (as |
| information | | detailed in Table 8.5.3.4-2) about EAS, the |
| filters | | EEC is interested in. |
| | | Applicable for “EAS dynamic information |
| | | change” event |
| Common EAS | O | Common EAS discovery filters (as detailed in |
| discovery | | Table 8.5.3.2-x). |
| filters | | Applicable for “Common EAS availability |
| | | change” event |
| EEC Service | O | Indicates if the EEC supports service continuity |
| Continuity | | or not. The IE also indicates which ACR |
| Support | | scenarios are supported by the EEC. |
| Proposed | O | Proposed expiration time for the subscription |
| expiration time | | |
| EAS | O | Indicates to the EES that EAS instantiation |
| Instantiation | | triggering may be performed for the current |
| Triggering | | request if needed. |
| Indication | | |

Alignment of “EAS Instantiation Triggering Indication” IF with the EAS discovery request procedure is for future study (FFS).

TABLE 8.5.3.4-2
EAS dynamic information filters

| Information | | |
|---|---|---|
| element | Status | Description |
| List of dynamic | M | List of EAS dynamic information required by |
| information | | the EEC per EAS. |
| filters | | |
| >EASID | M | Identifier of the EAS |
| >ACIDs | O | Flag to notify change in list of ACIDs |
| | | served by the EAS |
| >EAS | O | Flag to notify change in description of the EAS. |
| Description | | |
| >EAS Endpoint | O | Flag to notify change in EAS endpoint |
| >EAS Features | O | Flag to notify any change in features provided |
| | | by the EAS |
| >EAS Schedule | O | Flag to notify change in availability schedule |
| | | of the EAS (e.g. time windows) |
| >EAS Service | O | Flag to notify change in change in |
| Area | | geographical service area that the EAS serves |
| >EAS Service | O | Flag to notify change in characteristics of the |
| KPIs | | EAS. |
| >EAS Status | O | Flag to notify change in the status of the EAS |
| | | (e.g. enabled, disabled, etc.) |
| >Service | O | Flag to notify change in EAS support for |
| continuity | | service continuity. |
| support | | |

In an embodiment, clause 8.X of 3GPP TS 23.558 V18.2.0 may be added as following.

### 8.X Common EAS Retrieval

### 8.X.1 General

Common EAS retrieval procedure enables an EAS to obtain already selected common EAS(s) for an application group so that the request EAS can start communication with obtained EAS(s) for data synchronization.
NOTE: UEs in an application group can be in edge coverage of several non-overlapping EDNs, and each EDN has a common EAS to serve the application group. For UEs in the application group within overlapping EDN service area, still only one common EAS is selected to serve the AC in UE. All common EASs need to exchange data for serving the application group.

In an embodiment, clause 8.X.2 of 3GPP TS 23.558 V18.2.0 may be added as following.

### 8.X.2 Request-Response Model

### Pre-Conditions:

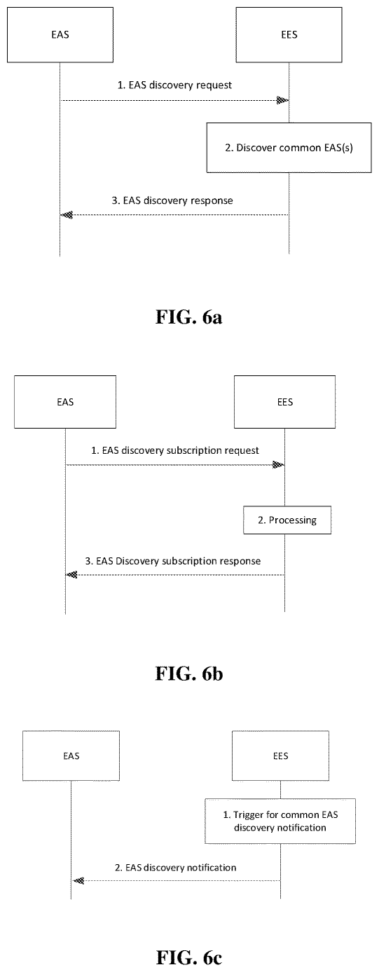

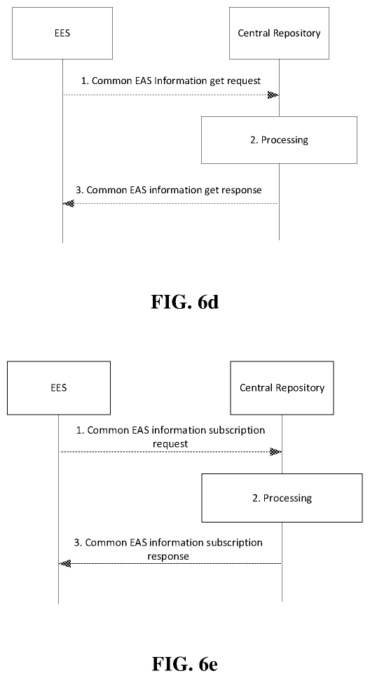

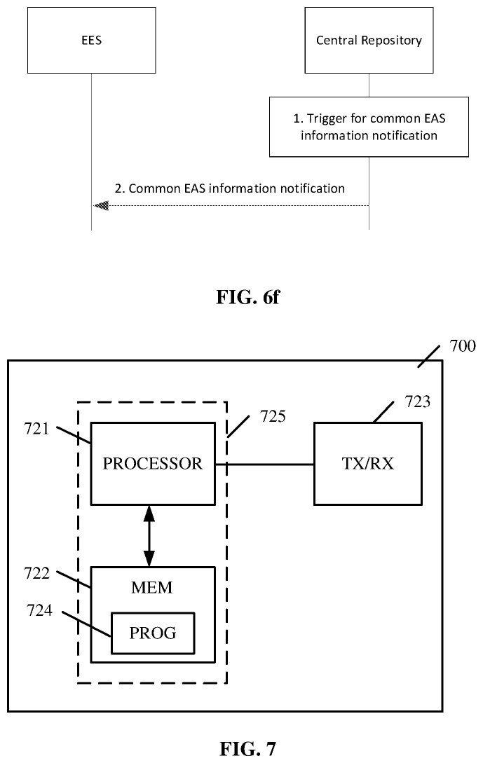

1. The EAS is aware of serving the application group.
FIG. 6a shows a flowchart of common EAS retrieval procedure according to another embodiment of the present disclosure.
1. The EAS sends EAS discovery request with EAS ID and Application Group ID in common EAS discovery filters. The inclusion of common EAS discovery filters indicates the request to obtain common EAS currently serving the Application Group ID with the requested EAS ID.
2. If Central Repository is available, the EES checks with the Central Repository with the received EAS ID and Application Group ID and obtains a list of EAS(s) serving the application group for the desired application service identified by the EAS ID as described in clause 8.Y.
NOTE: An empty EAS list is returned if the requesting EAS is the first EAS serving the application group.
3. The EES responds the EAS with common EAS information in EAS discovery response. Only EAS endpoint and EAS ID are included in EAS profile of Discovered EAS list.

In an embodiment, clause 8.X.3 of 3GPP TS 23.558 V18.2.0 may be added as following.

### 8.X.3 Subscribe-Notify Model

### 8.X.3.1 General

Clause 8.X.3.2 and clause 8.X.3.3 together illustrate the common EAS retrieval procedure based on Subscribe/Notify model.

In an embodiment, clause 8.X.3.2 of 3GPP TS 23.558 V18.2.0 may be added as following.

### 8.X.3.2 Subscribe

### Pre-Conditions:

1. The EAS may be aware of serving the application group.
FIG. 6b shows a flowchart of common EAS availability subscription procedure according to another embodiment of the present disclosure.
1. The EAS sends an EAS discovery subscription request to the EES. The EAS discovery subscription request includes Event ID indicating “Common EAS availability change” and include common EAS discovery filters.
2. The EES authorizes the subscription request. If it is authorized, the EES creates and stores the subscription for common EAS discovery. If the Central Repository is available, the EES subscribes to the Central Repository with event indicating common EAS availability, EAS ID and Application Group ID as described in clause 8.Y.
3. If the processing of the request was successful, the EES sends an EAS discovery subscription response to the EAS.

In an embodiment, clause 8.X.3.3 of 3GPP TS 23.558 V18.2.0 may be added as following.

### 8.X.3.3 Notify

### Pre-Conditions:

1. The EAS has subscribed with the EES for the common EAS availability event as specified in clause 8.X.3.2.
FIG. 6c shows a flowchart of common EAS availability notification according to another embodiment of the present disclosure.
1. An event occurs at the EES that satisfies trigger conditions for notifying (i.e. to provide common EAS discovery information) a subscribed EAS. If the Central Repository is available, the EES receives notification from the Central Repository about the common EAS discovery information.
2. The EES sends an EAS discovery notification to the EAS with the common EAS information determined in step 1. Only EAS endpoint and EAS ID are included in EAS profile of Discovered EAS list.

In an embodiment, clause 8.Y of 3GPP TS 23.558 V18.2.0 may be added as following.

8.Y Interaction with Central Repository

### 8.Y.1 General

This clause describes procedures and services provided by the Central Repository.

### 8.Y.2 Procedure

### 8.Y.2.1 General

Clause 8.Y.2.2, clause 8.Y.2.3 and clause 8.Y.2.4 illustrate the common EAS information retrieval procedures.

In an embodiment, clause 8.Y.2.2 of 3GPP TS 23.558 V18.2.0 may be added as following.

### 8.Y.2.2 Get Common EAS

FIG. 6d shows a flowchart of obtaining common EAS according to another embodiment of the present disclosure.
1. The EES sends common EAS information get request message to the Central Repository. The request message includes EAS ID and Application Group ID.
2. Upon receiving the request, the Central Repository checks if there are any stored common EAS(s) selected to serve the application group for the EAS ID.
3. If the processing of the request was successful, the Central Repository responds the EES with common EAS information identified in step 2.

In an embodiment, clause 8.Y.2.3 of 3GPP TS 23.558 V18.2.0 may be added as following.

### 8.Y.2.3 Common EAS Information Subscription

FIG. 6e shows a flowchart of subscribing common EAS information according to another embodiment of the present disclosure.
1. The EES sends common EAS information subscription request message to the Central Repository. The request message includes common EAS availability event, EAS ID and Application Group ID.
2. Upon receiving the request, the Central Repository authorizes the request and store the event subscription.
3. If the processing of the request was successful, the Central Repository responds the EES with common EAS information subscription response message.

In an embodiment, clause 8.Y.2.4 of 3GPP TS 23.558 V18.2.0 may be added as following.

### 8.Y.2.4 Common EAS Information Notification

### Pre-Conditions:

1. The EES has subscribed with the Central Repository for the common EAS availability event as specified in clause 8.Y.2.3.
FIG. 6f shows a flowchart of notifying common EAS information according to another embodiment of the present disclosure.
1. An event occurs at the Central Repository that satisfies trigger conditions for notifying (e.g. to provide common EAS information) a subscribed EES. When the Central Repository is aware of common EAS selected for application group for the EAS ID.
2. The Central Repository sends common EAS information notification to the EES with the common EAS information determined in step 1.

In an embodiment, clause 8.Y.3 of 3GPP TS 23.558 V18.2.0 may be added as following.

### 8.Y.3 Information Flows

### 8.Y.3.1 General

The information flows are specified for common EAS information service.

In an embodiment, clause 8.Y.3.2 of 3GPP TS 23.558 V18.2.0 may be added as following. It is noted that in addition to information elements in Table 8.Y.3.2-1, other information elements with the similar/same meanings may also be used. Table 8.Y.3.2-1 may comprise any other suitable information element.

### 8.Y.3.2 Common EAS Information Get Request

Table 8.Y.3.2-1 describes the information elements for common EAS information get request from the EES to the Central Repository.

TABLE 8.Y.3.2-1
Common EAS information get request

| Information | | |
|---|---|---|
| element | Status | Description |
| Requestor | M | The identifier of the EES. |
| identifier | | |
| Security | M | Security credentials resulting from a successful |
| credentials | | authorization for the edge computing service. |
| EAS ID | M | The identifier of the EAS. |
| Application | M | Identity of the group of UEs associated with |
| Group ID | | the EAS ID. |

In an embodiment, clause 8.Y.3.3 of 3GPP TS 23.558 V18.2.0 may be added as following. It is noted that in addition to information elements in Table 8.Y.3.3-1, other information elements with the similar/same meanings may also be used. Table 8.Y.3.3-1 may comprise any other suitable information element.

### 8.Y.3.3 Common EAS Information Get Response

Table 8.Y.3.3-1 describes the information elements for common EAS information get response from the Central Repository to the EES.

TABLE 8.Y.3.3-1
Common EAS information get response

| Information element | Status | Description |
|---|---|---|
| Successful response | O | Indicates that the request was |
| (NOTE) | | successful. |
| Failure response (NOTE) | O | Indicates that the request has failed. |
| >Cause | O | Indicates the failure cause. Only |
| | | included when Failure response is |
| | | included. |

NOTE:
One of these IEs shall be present in the message.

In an embodiment, clause 8.Y.3.4 of 3GPP TS 23.558 V18.2.0 may be added as following. It is noted that in addition to information elements in Table 8.Y.3.4-1, other information elements with the similar/same meanings may also be used. Table 8.Y.3.4-1 may comprise any other suitable information element.

### 8.Y.3.4 Common EAS Information Subscribe Request

Table 8.Y.3.4-1 describes the information elements for common EAS information subscribe request from the EES to the Central Repository.

TABLE 8.Y.3.4-1
Common EAS information subscribe request

| Information element | Status | Description |
|---|---|---|
| Requestor identifier | M | The identifier of the EES. |
| Security credentials | M | Security credentials resulting from a |
| | | successful authorization for the edge |
| | | computing service. |
| Notification Target | M | Notification Target Address where the |
| Address | | notification is to be sent. |
| Event ID | M | Event ID: |
| | | Common EAS availability |
| Common EAS | O | Applicable for event “Common EAS |
| availability info | | availability” event. |
| >EAS ID | M | The identifier of the EAS. |
| >Application Group | M | Identity of the group of UEs associated |
| ID | | with the EAS ID. |

In an embodiment, clause 8.Y.3.5 of 3GPP TS 23.558 V18.2.0 may be added as following. It is noted that in addition to information elements in Table 8.Y.3.5-1, other information elements with the similar/same meanings may also be used. Table 8.Y.3.5-1 may comprise any other suitable information element.

### 8.Y.3.5 Common EAS Information Subscribe Response

Table 8.Y.3.5-1 describes the information elements for common EAS information subscribe response from the Central Repository to the EES.

TABLE 8.Y.3.5-1
Common EAS information subscribe response

| Information element | Status | Description |
|---|---|---|
| Successful response | O | Indicates that the request was successful. |
| (NOTE) | | |
| >Subscription ID | M | Subscription identifier corresponding to |
| | | the subscription. |
| Failure response | O | Indicates that the request has failed. |
| (NOTE) | | |
| >Cause | O | Indicates the failure cause. Only included |
| | | when Failure response is included. |

NOTE:
One of these IEs shall be present in the message.

In an embodiment, clause 8.Y.3.6 of 3GPP TS 23.558 V18.2.0 may be added as following. It is noted that in addition to information elements in Table 8.Y.3.6-1, other information elements with the similar/same meanings may also be used. Table 8.Y.3.6-1 may comprise any other suitable information element.

### 8.Y.3.6 Common EAS Information Notification

Table 8.Y.3.6-1 describes the information elements for common EAS information notification from the Central Repository to the EES.

TABLE 8.Y.3.6-1
Common EAS information notification

| Information element | Status | Description |
|---|---|---|
| Subscription ID | M | Subscription identifier corresponding |
| | | to the subscription. |
| Event ID | M | Identify the subscribed event. |
| Common EAS | O | Applicable for event “Common EAS |
| availability info | | availability” event. |
| >common EAS | M | This IE includes a list of common EAS |
| information | | endpoints. |

Embodiments herein may provide many advantages, of which a non-exhaustive list of examples follows. In some embodiments herein, the proposed solution can support EAS to find other EASs providing the same service to the same application group. In some embodiments herein, the proposed solution can allow the EAS to start data synchronization with obtained common EASs. In some embodiments herein, a new service is provided by the central repository (CR) to offer common EAS information available in the CR so that other network function such as EAS can use the obtained common EAS information for various purposes. The embodiments herein are not limited to the features and advantages mentioned above. A person skilled in the art will recognize additional features and advantages upon reading the following detailed description.

FIG. 7 is a block diagram showing an apparatus suitable for practicing some embodiments of the disclosure. For example, any one of the EAS, the EES or the central repository described above may be implemented as or through the apparatus 700.

The apparatus 700 comprises at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the EAS, the memory 722 contains instructions executable by the processor 721, whereby the EAS operates according to any of the methods related to the EAS as described above.

In an embodiment where the apparatus is implemented as or at the EES, the memory 722 contains instructions executable by the processor 721, whereby the EES operates according to any of the methods related to the EES as described above.

In an embodiment where the apparatus is implemented as or at the central repository, the memory 722 contains instructions executable by the processor 721, whereby the central repository operates according to any of the methods related to the central repository as described above.

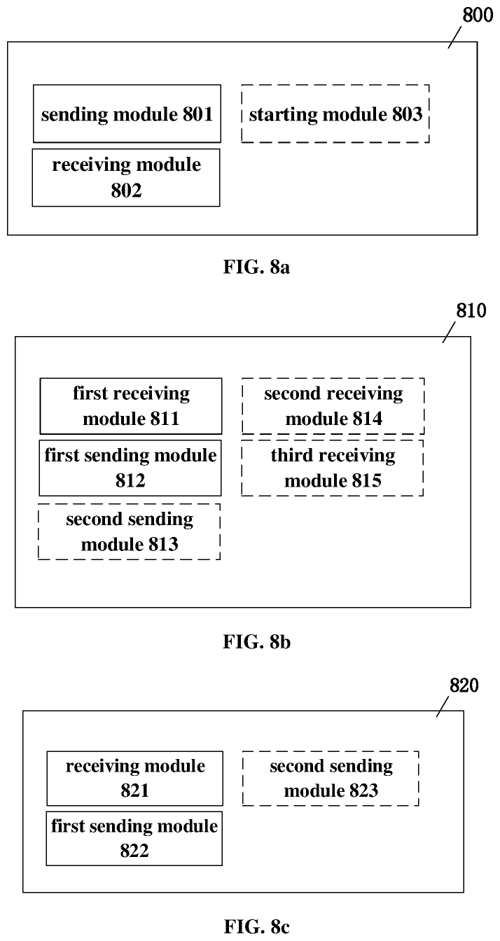

FIG. 8a is a block diagram showing an EAS according to another embodiment of the disclosure. As shown, the EAS 800 comprises a sending module 801 configured to send a first request to an edge enabler server (EES) or a central repository. The first request may be used for obtaining information of at least one common EAS currently serving an application group or subscribing for a common EAS availability event for the application group. The EAS 800 may further comprise a receiving module 802 configured to receive a first message from the EES or the central repository. The first message may comprise common EAS information for the application group. In an embodiment, the application group may be a group of UEs using a same application. In an embodiment, the first request may comprise an application group identifier identifying the application group.

In an embodiment, the EAS 800 may further comprise a starting module 803 configured to start data synchronization with at least one common EAS identified by the common EAS information for the application group.

FIG. 8b is a block diagram showing an EES according to an embodiment of the disclosure. As shown, the EES 810 may comprise a first receiving module 811 configured to receive a first request from an edge application server (EAS). The first request may be used for obtaining information of at least one common EAS currently serving an application group or subscribing for a common EAS availability event for the application group. The EES 810 may further comprise a first sending module 812 configured to send a first message to the EAS. The first message may comprise common EAS information for the application group. In an embodiment, the application group may be a group of UEs using a same application. In an embodiment, the first request may comprise an application group identifier identifying the application group.

In an embodiment, the EES 810 may further comprise a second sending module 813 configured to send a second request to a central repository. The second request may be used for obtaining the information of the at least one common EAS currently serving the application group or subscribing for the common EAS availability event for the application group. In an embodiment, the second request may comprise the application group identifier identifying the application group.

In an embodiment, the EES 810 may further comprise a second receiving module 814 configured to receive a second message from the central repository. The second message may comprise the common EAS information for the application group.

In an embodiment, when the second request is a common EAS information subscription request, the EES 810 may further comprise a third receiving module 815 configured to receive a common EAS information subscription response from the central repository.

FIG. 8c is a block diagram showing a central repository 820 according to an embodiment of the disclosure. As shown, the central repository 820 may comprise a receiving module 821 configured to receive a second request from an edge enabler server (EES) or a first request from an edge application server (EAS). The first request and/or the second request may be used for obtaining information of at least one common edge application server (EAS) currently serving an application group or subscribing for a common EAS availability event for the application group. The central repository 820 may further comprise a first sending module 822 configured to send a second message to the EES or a first message to the EAS. The first message and/or the second message may comprise common EAS information for the application group. In an embodiment, the application group may be a group of UEs using a same application. In an embodiment, the first request and/or the second request may comprise an application group identifier identifying the application group.

In an embodiment, when the second request is a common EAS information subscription request, the central repository 820 may further comprise a second sending module 823 configured to send a common EAS information subscription response to the EES.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the EAS, the EES or the central repository may not need a fixed processor or memory, any computing resource and storage resource may be arranged from the EAS, the EES or the central repository in the communication system. The introduction of virtualization technology and network computing technology may improve the usage efficiency of the network resources and the flexibility of the network.

Further, the exemplary overall commutation system including the terminal device and the network node will be introduced as below.

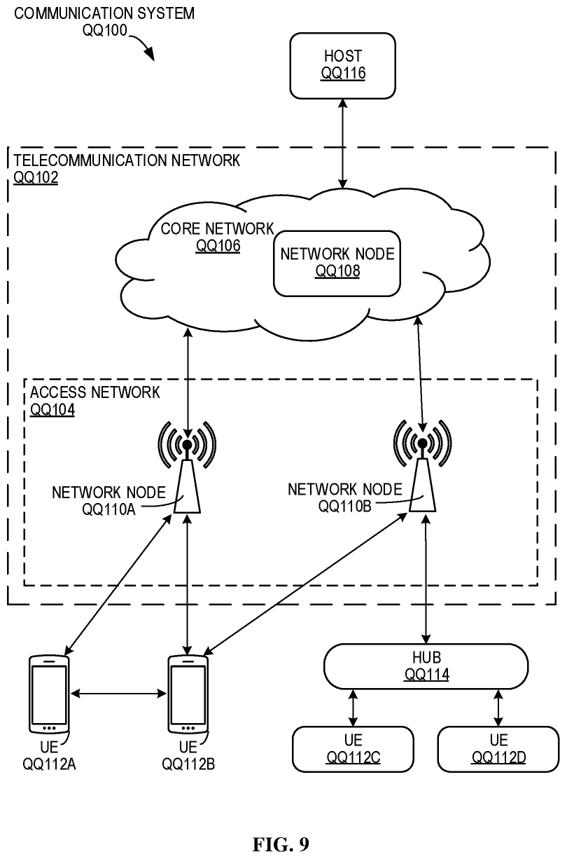

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application or a non-real time control application, or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

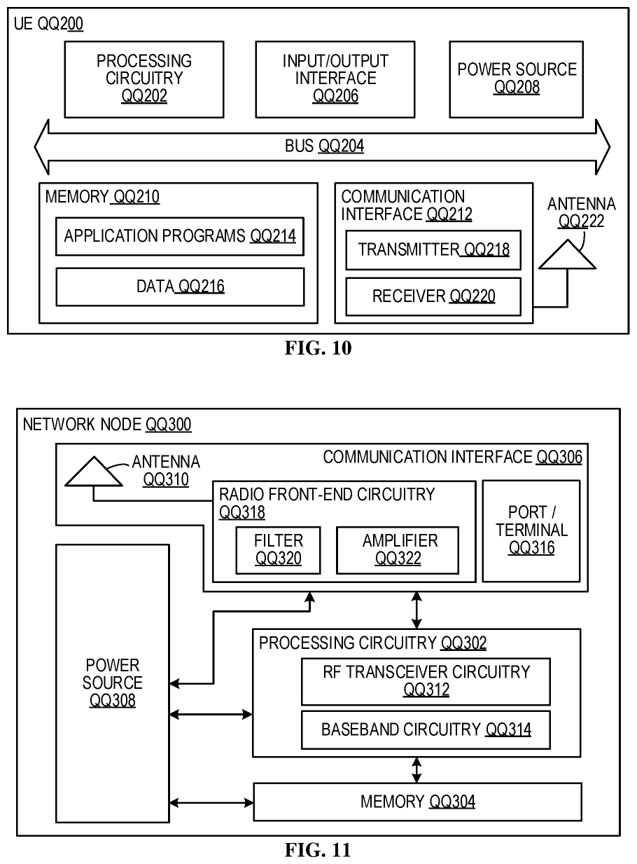

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

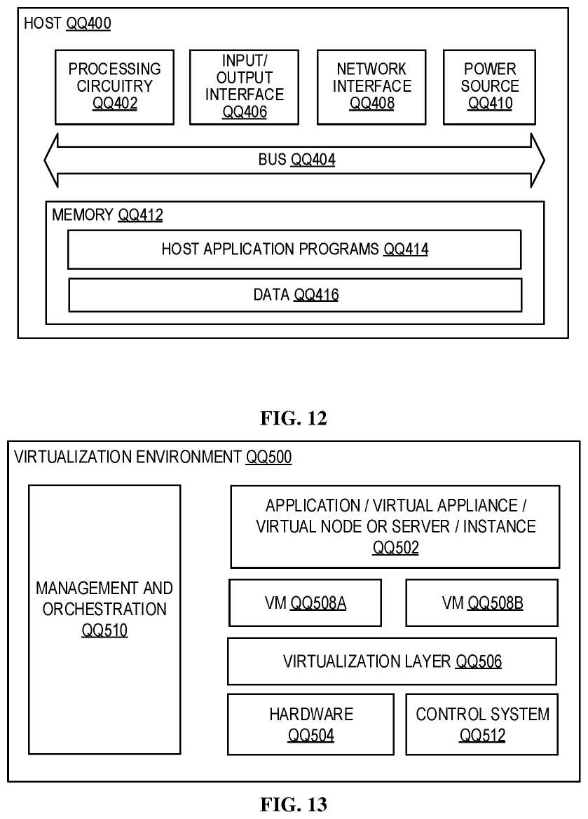

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508A and QQ508B (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

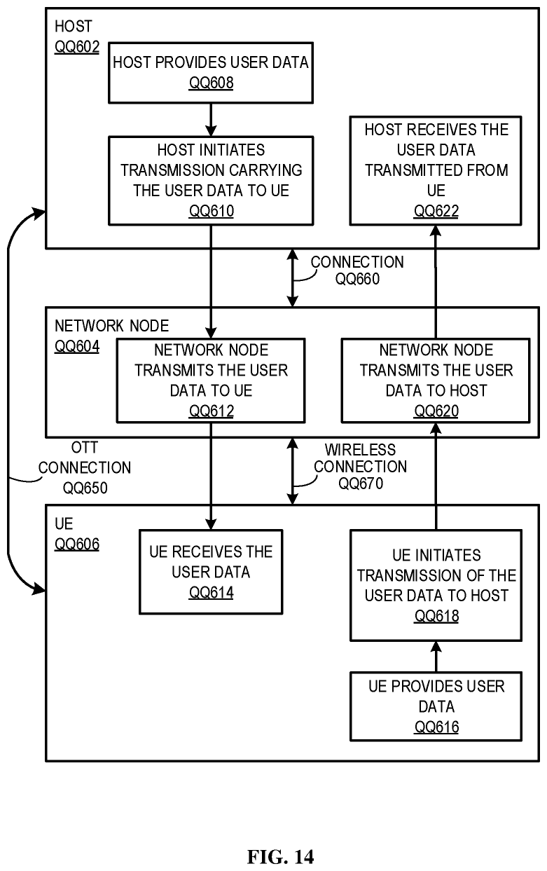

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, the proposed solution can support EAS to find other EASs providing the same service to the same application group. In some embodiments herein, the proposed solution can allow the EAS to start data synchronization with obtained common EASs. In some embodiments herein, a new service is provided by the central repository (CR) to offer common EAS information available in the CR so that other network function such as EAS can use the obtained common EAS information for various purposes.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations performed by the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations performed by the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations performed by the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations performed by the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations performed by the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations performed by the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations performed by the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations performed by the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs any of the operations performed by the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-57. (canceled)

58. A method performed by an edge application server (EAS), the method comprising:
sending a first request to an edge enabler server (EES) or a central repository, the first request being used to obtain information of at least one common EAS currently serving an application group or subscribing for a common EAS availability event for the application group, the application group being a group of User Equipments (UEs) using a same application, the first request comprising an application group identifier identifying the application group; and
receiving a first message from the EES or the central repository, the first message comprising common EAS information for the application group.

59. The method according to claim 58, wherein the first request comprises first information for determining the common EAS information for the application group; or
wherein the first request comprises first information for determining the common EAS information for the application group and an event identifier of common EAS availability change.

60. The method according to claim 59, wherein the first request further comprises an identifier of a requestor.

61. The method according to claim 59, wherein the first information comprises a first set of characteristics for determining the common EAS information for the application group; and
wherein the first set of characteristics comprises an EAS identifier and the application group identifier.

62. The method according to claim 58, wherein the first request comprises at least one of:
an EAS discovery request; or
an EAS discovery subscription request;
wherein the first message comprises at least one of:
an EAS discovery response; or
an EAS discovery notification;
wherein if the EAS is a first EAS serving the application group and the first request is an EAS discovery request, the common EAS information for the application group comprises an empty EAS list;
wherein the EAS is serving or is going to serve the application group; or
wherein at least one common EAS for the application group is deployed in a same edge data network or different edge data networks.

63. The method according to claim 58, further comprising:
starting data synchronization with at least one common EAS identified by the common EAS information for the application group.

64. A method performed by an edge enabler server (EES), the method comprising:
receiving a first request from an edge application server (EAS), the first request being used for obtaining information of at least one common EAS currently serving an application group or subscribing for a common EAS availability event for the application group, the application group being a group of User Equipments (UEs) using a same application, the first request comprising an application group identifier identifying the application group; and
sending a first message to the EAS, the first message comprising common EAS information for the application group.

65. The method according to claim 64, wherein the first request comprises first information for determining the common EAS information for the application group; or
wherein the first request comprises first information for determining the common EAS information for the application group and an event identifier of common EAS availability change.

66. The method according to claim 65, wherein the first request further comprises an identifier of a requestor.

67. The method according to claim 66, wherein the first information comprises a first set of characteristics for determining the common EAS information for the application group; and
wherein the first set of characteristics comprises an EAS identifier and the application group identifier.

68. The method according to claim 64, wherein the first request comprises at least one of:
an EAS discovery request; or
an EAS discovery subscription request;
wherein the first message comprises at least one of:
an EAS discovery response; or
an EAS discovery notification;
wherein if the EAS is a first EAS serving the application group and the first request is an EAS discovery request, the common EAS information for the application group comprised in the first message comprises an empty EAS list;
wherein the EAS is serving or is going to serve the application group; or
wherein at least one common EAS for the application group is deployed in a same edge data network or different edge data networks.

69. The method according to claim 65, further comprising:
sending a second request to a central repository, wherein the second request is used for obtaining the information of the at least one common EAS currently serving the application group or subscribing for the common EAS availability event for the application group, the second request comprises the application group identifier identifying the application group; and
receiving a second message from the central repository, wherein the second message comprises the common EAS information for the application group.

70. The method according to claim 69, wherein the second request comprises second information for determining the common EAS information for the application group; and
wherein the second request comprises second information for determining the common EAS information for the application group and an event identifier of common EAS availability event.

71. The method according to claim 70, wherein the second request further comprises at least one of:
an identifier of the EES; or
security credentials; or
wherein the second request further comprises at least one of:
an identifier of the EES;
security credentials; or
a notification target address.

72. The method according to claim 70, wherein the second information comprises a second set of characteristics for determining the common EAS information for the application group; and
wherein the second set of characteristics comprises an EAS identifier and the application group identifier.

73. The method according to claim 69, wherein the second request comprises at least one of:
a common EAS information get request; or
a common EAS information subscription request;
wherein the second message comprises at least one of:
a common EAS information get response; or
a common EAS information notification;
wherein when the second message is a common EAS information get response, the common EAS information get response comprises at least one of:
an information element indicating that the second request is successful or failed;
the common EAS information for the application group when the second request is successful; or
a failure cause when the second request is failed; or
wherein when the second message is a common EAS information notification, the common EAS information notification comprises at least one of:
a subscription identifier;
an event identifier; or
the common EAS information for the application group.

74. The method according to claim 69, wherein when the second request is a common EAS information subscription request, the method further comprises:
receiving a common EAS information subscription response from the central repository.

75. The method according to claim 74, wherein the common EAS information subscription response comprises at least one of:
an information element indicating that the second request is successful or failed;
a subscription identifier when the second request is successful; or
a failure cause when the second request is failed.

76. A method performed by a central repository, the method comprising:
receiving a second request from an edge enabler server (EES) or a first request from an edge application server (EAS), one or both of the first request and the second request being used for obtaining information of at least one common edge application server (EAS) currently serving an application group or subscribing for a common EAS availability event for the application group, the application group being a group of User Equipments (UEs) using a same application, the one or both of the first request and the second request comprising an application group identifier identifying the application group; and
sending a second message to the EES or a first message to the EAS, the one or both of the first message and the second message comprising common EAS information for the application group.

77. The method according to claim 76, wherein the one or both of the first request and the second request comprises information for determining the common EAS information for the application group; or
wherein the one or both of the first request and the second request comprises information for determining the common EAS information for the application group and an event identifier of common EAS availability event.

78. The method according to claim 77, wherein the one or both of the first request and the second request further comprises at least one of:
an identifier of a requestor; or
security credentials;
wherein the one or both of the first request and the second request further comprises at least one of:
an identifier of a requestor;
security credentials; or
a notification target address.

79. The method according to claim 77, wherein the information for determining the common EAS information for the application group comprises a set of characteristics for determining the common EAS information for the application group; and
wherein the set of characteristics comprises an EAS identifier and the application group identifier.

80. The method according to claim 76, wherein the one or both of the first request and second request comprises at least one of:
an EAS discovery request;
an EAS discovery subscription request;
a common EAS information get request; or
a common EAS information subscription request;
wherein the one or both of the first message and the second message comprises at least one of:
an EAS discovery response;
an EAS discovery notification;
a common EAS information get response; or
a common EAS information notification;
wherein when the second message is a common EAS information get response or the first request is an EAS discovery response, the common EAS information get response or the EAS discovery response comprises at least one of:
an information element indicating that the first/second request is successful or failed;
the common EAS information for the application group when the first/second request is successful; or
a failure cause when the first/second request is failed;
wherein when the second message is a common EAS information notification or the first message is an EAS discovery notification, the common EAS information notification or the EAS discovery notification comprises at least one of:
a subscription identifier;
an event identifier; or
the common EAS information for the application group; or
wherein when the second request is a common EAS information subscription request, the method further comprises:
sending a common EAS information subscription response to the EES.

81. The method according to claim 80, wherein the common EAS information subscription response comprises at least one of:
an information element indicating that the second request is successful or failed;
a subscription identifier when the second request is successful; or
a failure cause when the second request is failed.
